(19) United States
(12) Patent Application Publication
(10) Pub. No.: US 2008/0147409 A1
(43) Pub. Date: Jun. 19, 2008

(54) System, apparatus and method for providing global communications

(76) Inventor: Robert Taormina, Celebration, FL (US)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 11/640,676

(22) Filed: Dec. 18, 2006

(51) Int. Cl. G10L 21/00

(52) U.S. Cl. 704/270.1; 704/260; 704/E15.019

(57) ABSTRACT

A system, apparatus and method for transmitting and receiving messages over a wireless communications network, the communicating device including a computer platform having storage for one or more programs, a user interface that includes a visual display for displaying at least alphanumeric characters and a microphone for inputting speech of a user of the computerized communicating device a trackball module, the trackball module for inputting at least alphanumeric characters, a sensor for obtaining biodata from a user of the computerized paging device, and a speech translation program resident and selectively executable on the computer platform, whereupon initiating a message for transmission, the speech translation software interpreting the words of the user and translating them into a digital text format, the speech translation program may include an electronic dictionary, the electronic dictionary identifies a word by comparing an electronic signature of the word to a plurality of electronic signatures stored in the electronic dictionary.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a system, apparatus and method for global telecommunications. More particularly, this invention relates to a system, apparatus and method for global telecommunications across multiple communication platforms and provides paging capabilities, and speech-to-text and text-to-speech translation.

### BACKGROUND OF THE INVENTION

In recent years, wireless systems, such as cellular and the like, have come into their own as viable alternatives to land-based hard wired systems. In fact, many telephone users have come to rely almost exclusively on wireless telephones as their primary means of voice communications when away from their office or home. The wide use and broad appeal of wireless telephones is demonstrated by the fierce competition among wireless service providers to sign up subscribers.

Wireless communication systems represent a substantial improvement over land based systems with respect to convenience and the ability to make or receive telephone calls, send and receive facsimiles and text messages at many more times and from many more locations than possible using a land-based system. As wireless services have become more popular, subscribers have continued to demand more from them. Thus, the ability to conduct economical communications at any time and between any two locations in the world is now in great demand. Present wireless systems cannot meet this demand and are deficient in a number of areas including, their high service fees, lack of availability in many areas and limited service features such as providing text-to-voice and voice-to-text translations for messages, and wireless terminal security features.

The deficiencies of present wireless systems also apply to the wireless terminals including cellular telephones, personal data assistants (“PDA”), hand-held computers and other wireless telecommunication devices. As the services of the wireless systems increase, the functionality of wireless terminals will increase. Functions performed by hand-held wireless terminals require an increasing degree of user input and interaction. For example, a typical wireless terminal includes a display screen, a keypad, and a plurality of control buttons or switches to allow the user to scroll through menu options on the display screen. One such control is a dial that may be used to “roll” through menu options. Alternatively, forward and reverse buttons may be employed to accomplish this task. Finally, certain wireless terminals provide a trackball on the front face of the wireless terminal to position a cursor on the display screen; however these trackballs are limited in that they function basically as cursor pointing devices and do not provide for the inputting of alphanumeric characters and symbols.

Accordingly, there is a need for wireless communication systems that provide for global telecommunications including text-to-voice and voice-to-text translation messaging, and wireless terminals with enhanced data input interfaces.

### SUMMARY OF THE INVENTION

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description.

The present invention advantageously provides a system, method and apparatus for global communications.

A system, apparatus and method for transmitting and receiving messages over a wireless communications network, the communicating device including a computer platform having storage for one or more programs, a user interface that includes a visual display for displaying at least alphanumeric characters and a microphone for inputting speech of a user of the computerized communicating device a trackball module, the trackball module for inputting at least alphanumeric characters, a sensor for obtaining biodata from a user of the computerized paging device, and a speech translation program resident and selectively executable on the computer platform, whereupon initiating a message for transmission, the speech translation software interpreting the words of the user and translating them into a digital text format, the speech translation program may include an electronic dictionary, the electronic dictionary identifies a word by comparing an electronic signature of the word to a plurality of electronic signatures stored in the electronic dictionary.

In accordance with one aspect, the present invention provides a system for transmitting and receiving messages including at least one base station, the at least one base station having storage for one or more programs, at least one computerized communicating device, the at least one computerized communicating device including a computer platform having storage for one or more programs a display for displaying at least alphanumeric text, a trackball module, the trackball module providing for input of alphanumeric characters and a sensor for obtaining biodata from a user of the computerized communicating device, a first subsystem coupled to the user interface for processing speech from the user, the first subsystem operating so as to translate the speech from the user into a data stream of text; and a second subsystem coupled to the user interface for processing text from the user, the second subsystem operating so as to translate the text from the user into a data stream of speech. The system may further include a third subsystem coupled to the user interface for prompting the user to speak a reference word that is randomly selected from a set of reference words, the third subsystem operating so as to present the user with a graphical image on the visual display that has been predetermined to elicit a predetermined response from the user that is the selected word. The system may yet further include a fourth subsystem coupled to the microphone for authenticating the communicating device to operate in the wireless telecommunications system, when the speech characteristics of the user match the expected characteristics associated with the reference word.

In accordance with one aspect, the present invention provides a method for transmitting and receiving messages on a communication network using a computerized communicating device. The method for transmitting and receiving messages includes composing a message by use of an input element of a computerized communicating device, transmitting the message to a base station, converting the transmitted message from a first message format to a second message format, and transmitting the first formatted message and the converted second formatted message to a receiving device. The method for transmitting and receiving messages may include using an input element to input at least one alphanumeric character in a communicating device and selecting a menu option to transmit the message to the base station. The method for transmitting and receiving messages may include having a text message as the first message format and a voice message as the second message format.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a top perspective view of the global communicating device of the present invention;

FIG. 2 is a bottom perspective view of the global communicating device of the present invention;

FIG. 3 is a block diagram of the global communicating device within a communication network of the present invention; and

FIG. 4 is a block diagram of a global communicating device within another communication network of the present invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

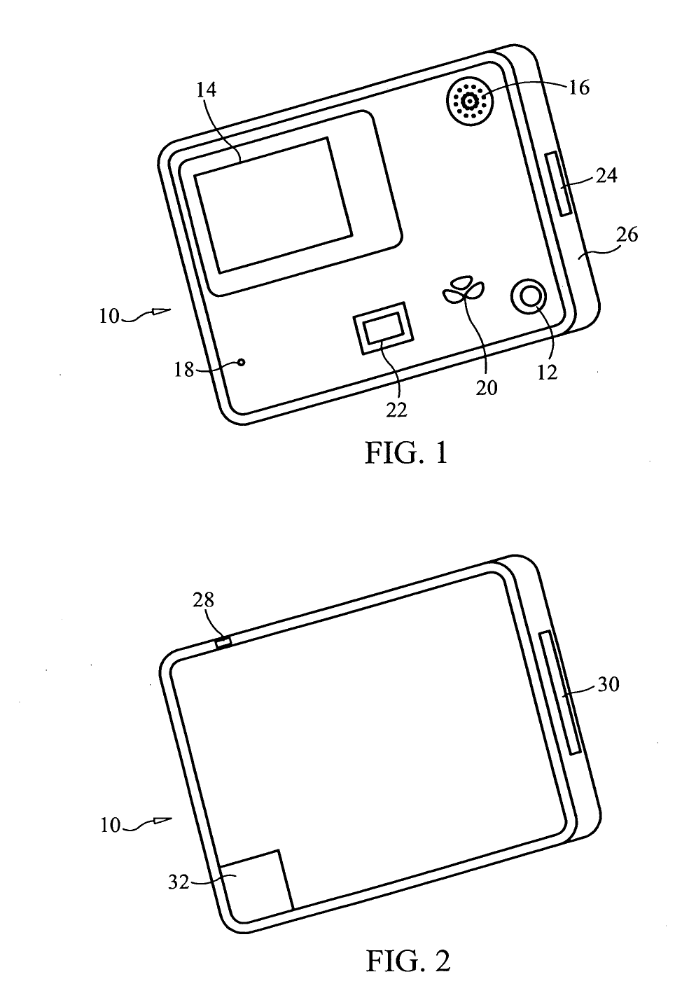

Referring now to FIG. 1, illustrated therein is a portable electronic telecommunication device embodied as a communicating device 10 that has text-to-speech and speech-to-text translation capabilities and security capabilities. The communicating device 10 includes a housing 26, a trackball/mouse 12 and a graphic display 14 that can display alphanumeric text and other graphics to the user of the communicating device 10 as well as others who can view the display 14. The communicating device 10 further includes user programmable buttons 20 and one or more speakers 16 which may be placed next to the user's ear during conversation, and a microphone 18, which converts the speech of a user into electronic signals for transmission from the communicating device 10. The communicating device 10 further includes a sensor 22 for receiving data, e.g., biodata from a user, and interface ports 24 e.g., telephony jack, USB port, etc., for interfacing with various systems including land-line, e.g., legacy plain old telephone service (“POTS”), personal computers, other portable computing devices and peripherals. The interface ports 24 provide for easy transfer of “off-device” data to the communicating device 10 for upgrade, reprogram, and synchronization with external devices.

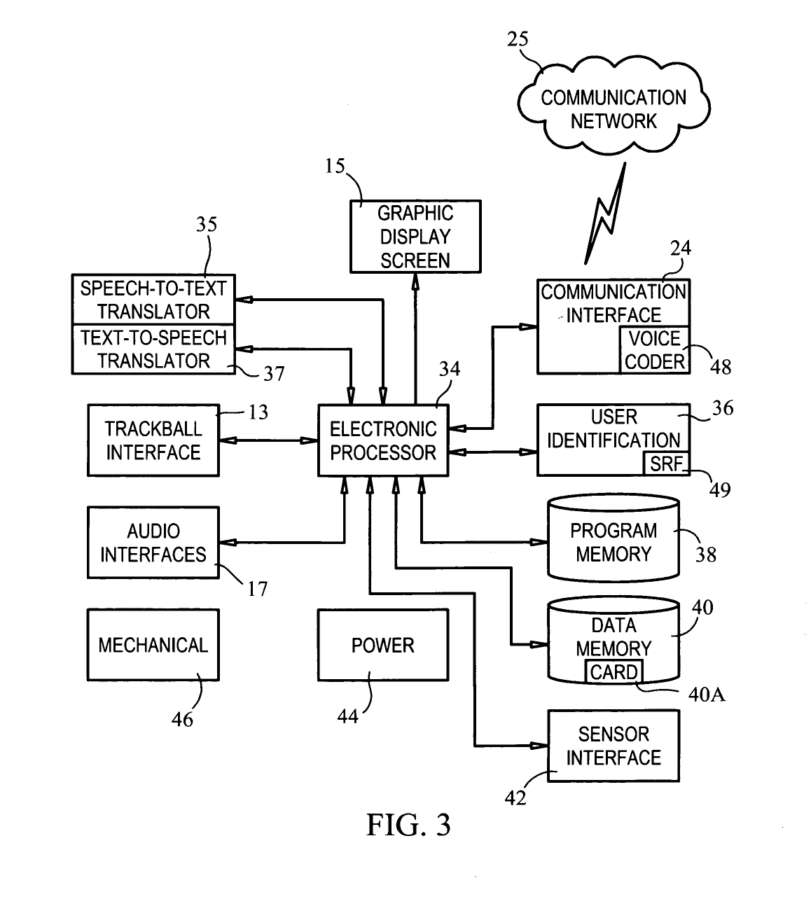

The communicating device 10 further includes a user interface, which can include a conventional speaker 16, a conventional microphone 18, a display 14, and a user input device, typically a trackball/mouse 12, all of which are coupled to an electronic processor 34 (shown in FIG. 3). The trackball/mouse 12 provides for inputting of a text message, email, or the like. In operation, the user of the communicating device 10 may depress the trackball 12 and rotate the ball to view the alphanumeric characters, e.g., letters and numbers from A to Z, space, grammatical marks, and 0 to 9. Upon locating the desired alphanumeric character or grammatical mark, the downward pressure of the trackball is released and that alphanumeric character or grammatical mark is placed in a sentence or word of a text window of display 14. As the user rotates the trackball from left to right, the user will see in large font size, e.g., 18-font for the characters, letters and numbers. When the user releases the pressure on the ball the letters may be reduced in font size, e.g., 12-font, and displayed in a text window of display 14. This text enlargement feature provides users with poor eyesight the ability to view the letters without straining their eyes. In addition, the trackball provides people the ability to “type” with one finger without having to look down at a very small keyboard. Once the message is complete, the user may access the operation menu to send the message.

FIG. 2 illustrates a bottom perspective view of the communicating device 10. The bottom perspective illustrates that communicating device 10 may further include a power jack 28, a PC card slot 30 and a battery access panel 32. The power jack 28 is connected to the power supply 44 (shown in FIG. 3), e.g., a battery and may provide an alternative power source for the communicating device 10 or to recharge the power supply 44. The battery access panel 32 provides for access to the power supply 44. The PC card slot 30 provides a connecting port for a PC card module such as communications interface module 24 (shown in FIG. 3).

The communicating device 10 also may have a computer platform in the form of an electronic processor 34, as shown in FIG. 3, which can interface with some or all of the other components of the communicating device 10. The electronic processor 34 of the communicating device 10 and its interaction with the other components is particularly shown in FIG. 3. The electronic processor 34 has storage for one or more programs and interacts with the various components of the communicating device 10. The electronic processor 34 particularly interfaces with the communications interface 24 that ultimately receives and transmits communication data to a communication network 25, such as a cellular network, satellite network or a broadcast wide area network (WAN). The electronic processor 34 may interface with the trackball interface 13, the graphic display 14, and the audio interfaces 17.

The electronic processor 34 may provide signals to and receives signals from the communications interface 24. These signals include signaling information in accordance with the air interface standard of the applicable cellular system, and also user speech and/or user generated data. The particular air interface standard and/or access type is not germane to the operation of this system, as mobile stations and wireless systems employing most if not all air interface standards and access types (e.g., TDMA, CDMA, FDMA, etc.) can benefit from the teachings of this invention. It is understood that the electronic processor 34 also includes the circuitry required for implementing the audio and logic functions of the communicating device 10. By example, the electronic processor 34 may be comprised of a digital signal processor device, a microprocessor device, and various analog to digital converters, digital to analog converters, and other support circuits. The control and signal processing functions of the communicating device 10 are allocated between these devices according to their respective capabilities. Alternatively, communications interface 24 can include the circuitry required for implementing the audio and logic functions of the communicating device 10. In many embodiments, the communicating device 10 will include a voice encoder/decoder (voice coder) 48 of any suitable type.

Referring to FIG. 3, the communicating device 10 further includes a trackball interface 13, which trackball interface 13 can receive and interpret the input from trackball 12 of the communicating device 10. The graphic display screen 15 displays alphanumeric text and other graphics on the display 14 of the communicating device 10, and displays the text of the translated speech of the communicating party to the user. The audio interfaces 17 are electronic interfaces for the physical components of the speaker 16 and microphone 18, each translating electronic signals either from or to audible speech.

The communications interface module 24 can include a modulator, a transmitter, a receiver and a demodulator or a communication protocol processor. Typically, the modulator and demodulator are integrated into a single unit and referred to as a modem, which is any device that transforms “base band” signals, either analog or digital, into another form for ease of transmission. The typical method employed in frequency modulation is to multiply the baseband signal by a carrier frequency that is suitable for wireless transmission. The communications interface module 24 is connected to the electronic processor 34 for use in transmitting and receiving signals under the control of the electronic processor 34. The communications interface module 24 is adapted for cellular and satellite communications. A cellular/satellite receiver including a receiver antenna is also connected to the modem of communications interface module 24, together with a cellular/satellite transmitter having a transmitting antenna providing the modem with cellular/satellite communication capabilities. It is anticipated that the transmitter and the receiver, as well as their respective antennas, may be integrated into a single transceiver with a single antenna, dual antennas or separate cellular and satellite antennas with corresponding transceiver circuitry.

When a message is received by the receiver antenna and cellular/satellite receiver, it is transmitted through the modem to the electronic processor 34. An optical LED message indicator may also be connected to the electronic processor 34, and can be activated by the electronic processor 34 to provide a visual indication that a message has been received. The LED message light can be controlled by the electronic processor 34 to either remain illuminated when a message is received or to blink indicating the number of messages received. The electronic processor 34 can also be connected to the message button and the graphic display screen 15 whereby, when a message is received and the message button is activated and the received message is displayed on the display screen 16. The optional message button can be a pressure operated switch which is activated by applying pressure thereto by a user. The trackball 12 is connected to the electronic processor 34 via the trackball interface 13 and can be used to scroll through the message displayed on the display screen 15. A speaker 16 can also be connected to the electronic processor 34, via audio interface 17, to provide an audible representation of the received message.

The program memory 38 and data memory unit 40 are also connected to the electronic processor 34. The program memory 38 stores the programming used in controlling the operation of the communicating device 10 by the electronic processor 34 and the memory unit 40 stores data, which may include transmitted and received messages and emails, user authentication information, security information, a classified telephone directory, personal schedule data and the like. A microphone 18 is connected to the electronic processor 34 via the audio interface 17 for inputting either a new message for transmission to another party or a response to a received message. When the user speaks into the microphone 18, the voice data (an analog signal representative of the user's speech) is converted from the analog signals into digital signals by the electronic processor 34 for transmission to another party.

In accordance with the teachings of this invention, the electronic processor 34 can have a speech translation program module 35 (speech-to-text) resident and selectively executable thereupon, and when called, the program module 35 translates speech from either the communicating party or the user of the communicating device 10 into a data stream of text (text format) comprised of text words ideally for each spoken word. There is also a text translation program module 37 (text-to-speech) that is resident on the electronic processor 34, and the program module 37 translates text input from the trackball interface 13 into speech, as is further discussed herein. The electronic processor 34 can further have additional program modules that allow the communicating device 10 to receive communication data streams from the communication network 25 and the communications interface 24 and display the text of the information from the communication data stream on the graphic display 14 with graphic display screen control 15.

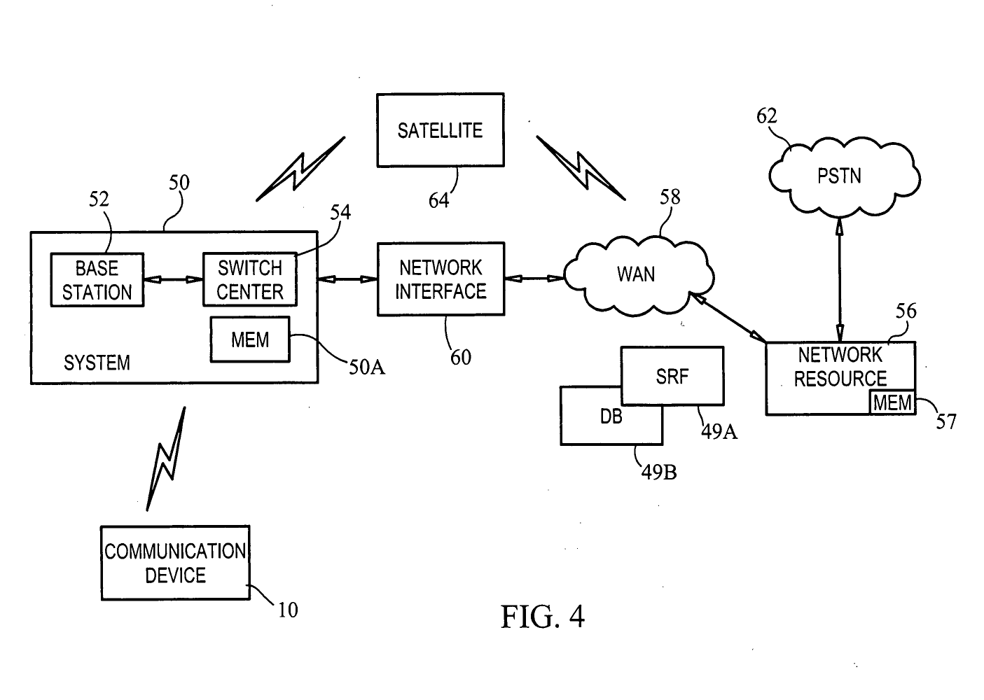

In another embodiment, the speech translation program module 35 and the text translation program module 37 functions can be distributed at a cell site and be stored in some other memory, or in a memory 50A located in the system 50 (shown in FIG. 4), or in some remote memory that is accessible through the system 50. The communicating device 10 includes communications interface 24 for transmitting signals to and for receiving signals from a base site or base station 52. The base station 52 is a part of a wireless telecommunications network or system 50 that may include a mobile switching center 54. The switching center 54 provides a connection to landline trunks, such as the public switched telephone network (“PSTN”) 62, when the communicating device 10 is involved in a call. The system 50 provides satellite connections to the satellite 64 and the wireless networks.

In accordance with the teachings of this invention, the communicating device 10 can have a user identification module 36 that includes an authorization function that receives digitized input that originates from the sensor 22 via sensor interface 42, and which is capable of processing the digitized input and for comparing characteristics of the user's biodata (such as fingerprint, voiceprint, retina, facial image) with pre-stored characteristics stored in a memory 40 or user identification memory. If a match occurs then the user identification module 36 is operable to grant the speaker access to some resource, for example to a removable electronic card 40A in memory 40 which authorizes or enables the user to, in a typical application, sent a message from communicating device 10. For example, the subscriber data required to make a telephone call, such as the mobile identification number (MIN), and/or some authentication-related key or other data, can be stored in the card 40A, and access to this information is only granted when the user provides an authentication identification, e.g., a fingerprint, a retina scan, a facial image or the like that will match predetermined authentication data already stored in the memory 40 or user identification memory. Further in accordance with this invention, the predetermined authentication data could as well be stored in some other memory, such as memory 40M within the card 40A, or in a memory 50A located in the system 50 (shown in FIG. 4), or in some remote memory that is accessible through the system 50.

In accordance with the teachings of this invention, the user identification module 36 includes a speech recognition function (SRF) 49 that receives digitized input that originates from the audio interfaces 17, and which is capable of processing the digitized input and for comparing characteristics of the user's speech with pre-stored characteristics stored in a memory 40. If a match occurs then the user identification module 36 is operable to grant the speaker access to some resource, for example to a removable electronic card 40A in memory 40 which authorizes or enables the speaker to, in a typical application, sent a message from communicating device 10. For example, the subscriber data required to make a telephone call, such as the mobile identification number (MIN), and/or some authentication-related key or other data, can be stored in the card 40A, and access to this information is only granted when the user speaks a word or words that are expected by the SRF 49, and which match predetermined enrollment data already stored in the memory 40. Further in accordance with this invention, the predetermined enrollment data could as well be stored in some other memory, such as memory 40M within the card 40A, or in a memory 50A located in the system 50 (shown in FIG. 4), or in some remote memory that is accessible through the system 50.

Referring to FIG. 4, it can also be appreciated that the SRF 49 can be resident outside of the communicating device 10, such as at one or more network entities or resources 56 (e.g., a credit card supplier, stock broker, retailer, or bank.) In this embodiment, and assuming for example that the user wishes to access his account at the bank 56, the SRF 49 signals back to the communicating device 10 a randomly selected word to be spoken by the user, via the network 58, network interface 60, and wireless system 50. The user speaks the word and, in one embodiment, the spectral and temporal characteristics of the user's utterance are transmitted from the communicating device 10 as a digital data stream (not as speech per se) to the SRF 49 of the bank 56 for processing and comparison. In another embodiment the user's spoken utterance is transmitted in a normal manner, such as by transmitting voice encoder/decoder (voice coder 48) parameters, which are converted to speech in the system 50. This speech is then routed to the SRF 49 of the bank 56 for processing and comparison. It should be noted that the spectral and temporal characteristics transmitted in the first embodiment could be the voice coder 48 output parameters as well, which are then transmitted on further to the SRF 49 of the bank 56, without being first converted to a speech signal in the system 50. In this case, the necessary signaling protocol must first be defined and established so that the system 50 knows to bypass its speech decoder.

It is also within the scope of the teaching of this invention to provide a centralized SRF 49A, whose responsibility it is to authenticate users for other locations. For example, assume that the user of the communicating device 10 telephones the bank 56 and wishes to access an account. In this case, the user authentication process is handled by the intervention of the SRF 49A which has a database (DB) 49B of recognition word sets and associated speech characteristics for a plurality of different users. The SRF 49A, after processing the speech signal of the user, signals the bank 56 that the user is either authorized or is not authorized. This process could be handled in several ways, such as by connecting the user's call directly to the SRF 49A, or by forwarding the user's voice characteristics from the bank 56 to the SRF 49A. In either case the bank 56 is not required to have the SRF 49, nor is the other network resources.

In use, the communicating device 10 can either make or receive calls and selectively activate the speech translation module 35 or text translation module 37 on the electronic processor 34 to have the communicating party receive either a speech or text data stream from the user. Further, if the communicating party is a calling party, the call itself can prompt one of the translation modules to be executed at the connection of the incoming phone call. When the message is typed in full the user may then send it using the menu to send the message. The communicating device 10 then initiates a call to the cell site where either a satellite or cellular communication connection is established to anywhere in the world. The user may either read the text message or choose to listen to the message. The user may type in a command, verbalize a command or depress a button to initiate verbal prompts. If the user chooses to listen to the message, the user could state a command, such as “please read it to me”. The communicating device 10 will then “read” the text message to the user.

In one embodiment, the system operates to have the cell site transmit the message in both text format and voice format. In this embodiment, the user is simply selecting which format they wish to receive the message. By doing this, a user may send a text message that may be converted to a voice/speech message at the cell site by an automatic speech recognition program (“ASR”) which may operate in conjunction with human speech recognition (“HSR”) program, which message then may be transmitted to a land line, cell, fax or communicating device 10.

When a user desires to transmit a voice message, the user depresses a button that prompts the device to request the identity of the intended recipient. A user may response manually or verbally, e.g., with one of the key names in the user's address book. The communicating device 10 then makes a call to a cell site where either a satellite or cellular connection may be established anywhere in the world. In this embodiment, the message is translated at the site from voice communication data stream into a text format and then transmitted as an email attachment (text file) or text message. The text data may be converted at the cell site using ASR and HSR. In this case, the processing power of the cell cite is superior to the processing power of the communicating device 10 which may provide greater accuracy and speed in the translation of the communication data stream, and may allow the user to avoid having to view the graphic display screen 15. If a voice message is not understood, a verbal message can be sent back to the user to correct or clarify the message or portion of the message. The user may be prompted verbally to repeat the portion of the message that was not understood.

Additionally, by providing the translation function at the cell site, the memory demands and power demands of the communicating device are reduced and the complexity of the communications interface 24 may be reduced as well because only the cellular communication circuitry would be required at the device 10 level while the satellite communication circuitry would be available at the cell site level.

When the communicating device 10 is receiving speech through a communication link from the communication network 25 with a communication party and then translating the speech into text. A communication connection is established between the communicating device 10 and a communicating party. The communication connection can be either making or receiving a call from the communicating device 10. If the communication connection has a voice stream being sent to the communicating device 10, then the electronic processor 34 receives the voice stream via communication interface 24, and calls the speech translation module 35. Each word in the voice stream is then parsed, and then a determination is made as to whether the parsed word is known to a resident dictionary on the electronic processor 34.

The term dictionary is simply a data store of the electronic signatures of words. To identify a word, the electronic signatures of each word are compared in the dictionary to determine the text equivalent. Other speech-to-text conversion programs such as Dragon and Via Voice can be used on the computer platform (here electronic processor 34) as well.

If the word is not located in the dictionary, then the electronic organizer stores the word for later review. While the simple storage of the unknown word is not a necessary step, it is advantageous because the voice stream will continue to be processed and the continuity of conversation is not lost. The stored words can later be reviewed to determine if there was an error in interpretation or if the words are new and should be added to the dictionary. If the word is located after comparison in the dictionary, then the text word is obtained from the dictionary, and then the text word is sent to the graphic display control 14 and ultimately displayed on the graphic display 15 of the communicating device 10. If sufficient memory is present in the electronic processor, the entire text from the communication can be saved and selectively recalled.

When text is input at the trackball 12 and is interpreted by the electronic processor 34 and translated into audible speech and sent to the communicating party. The text being typed by the user is received at the electronic processor 34 from the trackball interface 13. The electronic processor 34 calls the text translation 37 and then each word of text is parsed.

A decision is made as to whether the parsed word is in the dictionary, and if not, the user is prompted to reenter the word. Then control of the executing text translation module 37 is returned to the electronic processor 34 which waits until it receives the reentered word. If the text word is recognized, then the text word is translated to its speech equivalent, and the electronic signal to create the audible word from the textual word is sent to the communication interface 24. There are several software programs in the art, which can generate the electronic signals to speakers that can recreate speech sufficient to audibly communicate words.

When translation of speech from the user of the communicating device 10 into text data which is sent to the communicating party, the speech translation module 35 is activated on the electronic processor 34, and then the voice stream is received in electronic form at the electronic processor 34 from the audio interface 17 for the microphones. Each word in the voice stream is parsed, and then a decision is made as to whether the word is known in the dictionary.

If the word is not known (i.e., located) then the user is prompted to restate the word, either at the display 14 or audibly at the speaker 16. Then the program will again receive the word spoken by the user. If the word is known in the dictionary, then the textual equivalent of the word is obtained from the dictionary, and the text is transmitted to the communication interface 24 for ultimate transmission across the communication network 25 to the communicating party.

As mentioned previously, although the last set of use examples provides for the speech translation program module 35 and the text translation program module 37 to reside on communicating device 10, the speech translation program module 35 and the text translation program module 37 functions can be distributed at a cell site and be stored in some other memory, or in a memory 50A located in the system 50 (shown in FIG. 4), or in some remote memory that is accessible through the system 50. Moreover, any of the programs, modules, subsystems discussed with respect to the communicating device 10 can be distributed at a cell site and be stored in some other memory, or in a memory 50A located in the system 50 (shown in FIG. 4), or in some remote memory that is accessible through the system 50.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. For example, while one preferred embodiment is a communicating device, the invention could equally be applied to two-way radios, two-way pagers, and the like.

The present invention can be realized in hardware, software, or a combination of hardware and software. An implementation of the method and system of the present invention can be realized in a centralized fashion in one computing system or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general-purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. A variety of modifications and variations are possible in light of the above teachings without departing from the spirit or essential attributes thereof, and accordingly, reference should be had to the following claims, rather than to the foregoing specification, as indicating the scope of the of the invention.

1. A computerized communicating device for transmitting and receiving messages comprising:
a computer platform having storage for one or more programs;
a user interface that includes a visual display for displaying at least alphanumeric characters and a microphone for inputting speech of a user of the computerized communicating device;
a trackball module, the trackball module for inputting at least alphanumeric characters;
a sensor for obtaining biodata from a user of the computerized paging device; and
a speech translation program resident and selectively executable on the computer platform, whereupon initiating a message for transmission, the speech translation software interpreting the words of the user and translating them into a digital text format;
wherein the speech translation program comprises an electronic dictionary, wherein the electronic dictionary identifies a word by comparing an electronic signature of the word to a plurality of electronic signatures stored in the electronic dictionary.

2. The device of claim 1, wherein the trackball module provides a text enlargement feature, the text enlargement feature being responsive to movement of a trackball of the trackball module, the movement being to depress and rotate the trackball.

3. The device of claim 1, wherein the speech translation program further interprets the words of the user of the communicating device and translates the words into text for transmission to the communicating party in an electronic format.

4. The device of claim 1 further comprising a text translation program resident and selectively executable on the computer platform, wherein the text translation program receives and interprets a stream of communication data containing information from the communicating party and the text translation program further displaying representative text of the information contained in the communication data on the display of the communicating device.

5. The device of claim 1 further comprising a user identification program resident and selectively executable on the computer platform, wherein the user identification program includes an authorization function that receives and compares a stream of communication data containing biodata information of a user with pre-stored biodata characteristics to determine when a user may operate the communicating device in a wireless network.

6. The device of claim 1 further comprising a user identification program resident and selectively executable on the computer platform, wherein the user identification program includes a speech recognition function that receives and compares a stream of communication data containing speech information of a user with pre-stored speech characteristics to determine when the stream of communication data can be transmitted to a communicating party.

7. The device of claim 1, wherein if the electronic signature of the word is not among the plurality of electronic signatures stored in the dictionary, the speech translation program stores the word in the electronic dictionary for later review.

8. A communication system for transmitting and receiving messages comprising:
at least one base station; the at least one base station having storage for one or more programs;
at least one computerized communicating device, the at least one computerized communicating device having
a computer platform having storage for one or more programs;
a display for displaying at least alphanumeric text;
a trackball module, the trackball module providing for input of alphanumeric characters; and
a sensor for obtaining biodata from a user of the computerized communicating device;
a first subsystem coupled to the user interface for processing speech from the user, the first subsystem operating so as to translate the speech from the user into a data stream of text; and,
a second subsystem coupled to the user interface for processing text from the user, the second subsystem operating so as to translate the text from the user into a data stream of speech.

9. A system as in claim 8, wherein one or both of the first and second subsystems are located in one of the communicating device, in the base station or in a controller coupled to the base station, or in a data communications network entity that is coupled through a data communications network to the wireless telecommunications system.

10. A system as in claim 9, wherein the data communications network is comprised of the Internet.

11. A system as in claim 8, wherein at least said second subsystem is located in a network entity that is coupled to a data communications network that is bidirectionally coupled to the wireless telecommunications system.

12. A system as in claim 8, further comprising a third subsystem coupled to the user interface for prompting the user to speak a reference word that is randomly selected from a set of reference words, the third subsystem operating so as to present the user with a graphical image on the visual display that has been predetermined to elicit a predetermined response from the user that is the selected word.

13. A system as in claim 12, further comprising a fourth subsystem coupled to the microphone for authenticating the communicating device to operate in the wireless telecommunications system, when the speech characteristics of the user match the expected characteristics associated with the reference word.

14. A system as in claim 12, wherein the selected word that is elicited from the user as the predetermined response is other than a generic name for an object that is represented by the graphical image.

15. The system of claim 13 further comprising a fifth subsystem coupled to the user interface for identifying and authorizing a user to operate the communicating device in a wireless network, the fifth subsystem includes an authorization function that receives and compares a stream of communication data containing biodata information of a user with pre-stored biodata characteristics to determine when a user may operate the communicating device in a wireless network.

16. A system as in claim 12, wherein the third subsystem employs the user interface to also present alphanumeric text to the user using the display of the communicating device.

17. A method for transmitting and receiving messages on a communication network using a computerized communicating device, the method comprising:
receiving a message via the communication network:
inputting a user's speech information by use of an input element of said computerized communicating device;
transmitting the user's speech information to a base station;
comparing the user's speech information with the message and pre-stored speech characteristics at the base station;
generating an authorization signal; and
outputting the authorization signal.

18. (canceled)

19. (canceled)

20. (canceled)

21. The method of claim 17, wherein the message is generated by a network resource and transmitted to the base station and communication device, and wherein the authorization signal is received by the network resource.

22. The method of claim 21, wherein the message elicits the user's speech information.

23. The method of claim 22, further comprising:
translating the message into a speech format; and
outputting the speech format so that the user can listen to the message.
